(19) United States
(12) Patent Application Publication
(10) Pub. No.: US 2012/0316479 A1
(43) Pub. Date: Dec. 13, 2012

(54) COMPRESSION DEVICE HAVING A PAUSE FEATURE

(75) Inventors: Scott MacMeans, Wrentham, MA (US); Malcolm G. Bock, Medfield, MA (US); Ilona Kuranda, Mansfield, MA (US)

(73) Assignee: TYCO HEALTHCARE GROUP LP, Mansfield, MA (US)

(21) Appl. No.: 13/488,972

(22) Filed: Jun. 5, 2012

Related U.S. Application Data
(60) Provisional application No. 61/495,466, filed on Jun. 10, 2011.

(51) Int. Cl. A61H 7/00

(52) U.S. Cl. 601/150; 601/152

(57) ABSTRACT

A compression device for providing compression treatment to a limb of a wearer includes a compression garment positionable on the limb of the wearer. The garment includes at least one inflatable bladder for providing compression treatment to the limb. A controller is adapted for fluid connection with the inflatable bladder and configured for cyclically inflating and deflating the bladder to provide the compression treatment. The controller is configured to temporarily pause the compression treatment for a set period of time without resetting the compression device.

### REFERENCE TO RELATED CASE

This application is the nonprovisional application of U.S. Provisional Application Ser. No. 61/495,466 filed Jun. 10, 2011, the entirety of which is incorporated by reference.

### FIELD OF THE INVENTION

The present invention generally relates to a compression device, and in particular to a compression device having a pause feature.

### BACKGROUND OF THE INVENTION

A compression device is often used to apply compression therapy to a patient to promote blood flow in a limb. A compression device typically includes a compression garment worn about a limb, such as a compression sleeve, and a controller. During the course of compression treatment, it may become necessary or desirable to periodically disable the compression device for a specific period of time to allow the patient to perform tasks either without the compression device or with the compression device in a disabled condition. For instance, times when the patient needs to fall asleep, use the bathroom or engage in physical therapy may require the patient to remove or disable the compression device. Typically, a patient or caregiver must completely turn off or otherwise resetting the device which requires the caregiver to reapply the sleeve and restart the controller to reinitiate the compression treatment. Frequently, the compression sleeve operation is not re-initiated promptly after the reason for turning off or resetting the device no longer exists. This causes undesirable gaps in treatment if the patient or caregiver neglects to restart the compression device. Further, the start-up sequence of the controller may be time consuming when restarting from an off or reset condition. Therefore, there exists a need for a compression device that allows a patient or caregiver to more fully control the time and duration of compression therapy.

### SUMMARY OF THE INVENTION

In one aspect, a compression device for providing compression treatment to a limb of a wearer generally comprises a compression garment positionable on the limb of the wearer. The garment comprises at least one inflatable bladder for providing compression treatment to the limb. A controller is adapted for fluid connection with the inflatable bladder and configured for cyclically inflating and deflating the bladder to provide the compression treatment. The controller is configured to temporarily pause the compression treatment for a set period of time without resetting the compression device.

In another aspect, a method of providing compression treatment to a limb of a wearer using a compression device including an inflatable bladder positioned on the limb of the wearer and a controller in fluid connection with the inflatable bladder generally comprises initiating compression treatment by cyclically inflating and deflating the bladder with pressurized fluid from the controller to compress the limb of the wearer. And temporarily pausing the compression treatment for a set period of time without resetting the compression device.

In yet another aspect, a controller for a compression device adapted to provide compression treatment to a limb of a wearer is adapted for fluid connection with an inflatable bladder of the compression device and configured for cyclically inflating and deflating the bladder to provide the compression treatment. The controller includes a processor programmed to temporarily pause the compression treatment for a set period of time without resetting the compression device.

### BRIEF DESCRIPTION OF THE DRAWINGS

FIG. 1 is a schematic of a compression device comprising a controller and a compression garment of the present invention;

FIG. 2 is a schematic of a processor in the controller;

FIG. 3 is a flow chart of a suspend mode pause algorithm;

FIG. 4 is a flow chart of a sleep mode pause algorithm; and

FIG. 5 is a perspective of the controller.

Corresponding reference characters indicate corresponding parts throughout the drawings.

### DESCRIPTION OF THE PREFERRED EMBODIMENTS

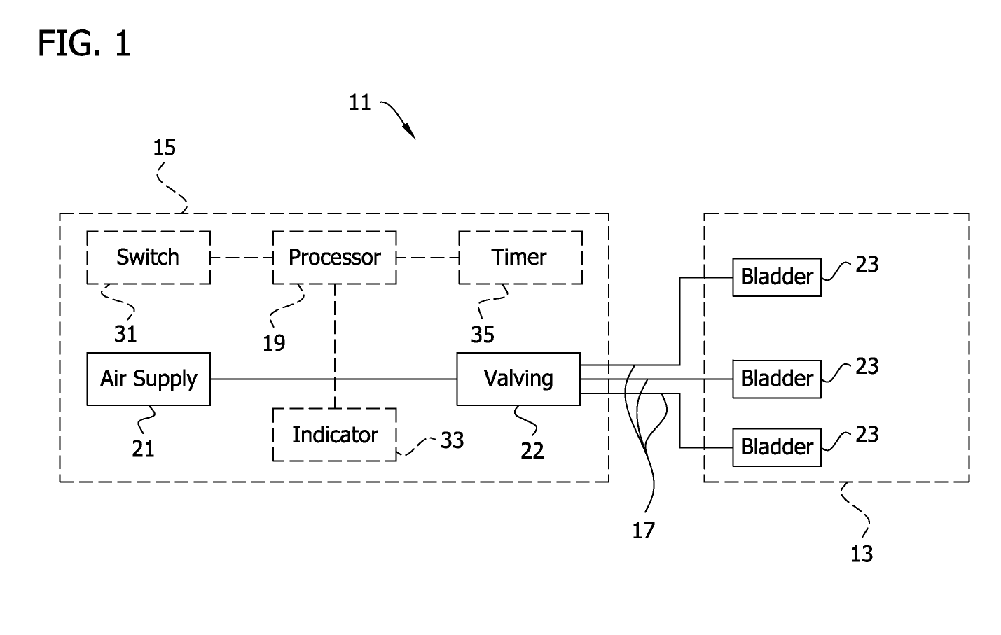

Referring to FIG. 1, a compression device of the present invention is generally indicated at 11. The compression device comprises a compression garment 13 for wrapping around a limb of a user and a controller 15 connected, for example, via tubing 17, to the garment. The controller has a processor 19 operatively connected to an air supply 21 (e.g., a compressor, hospital compressed air, etc.) and to valving 22 which provides compressed air to three inflatable bladders 23 of the garment 13. If an onsite compressed air source distinct from the compression device is used, the processor 19 may not need to be connected to the air supply 21. The compression device 11 is configured to provide compression therapy to the limb of the user via cyclic inflation of the bladders 23. Although three bladders 23 are illustrated, the garment 13 can have one, two or more than three bladders without departing from the scope of the invention.

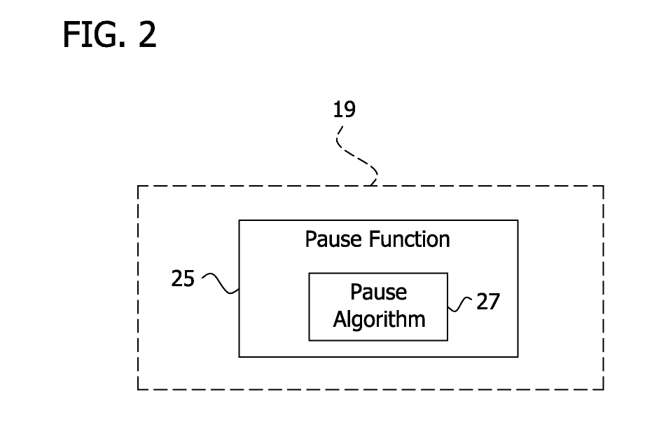

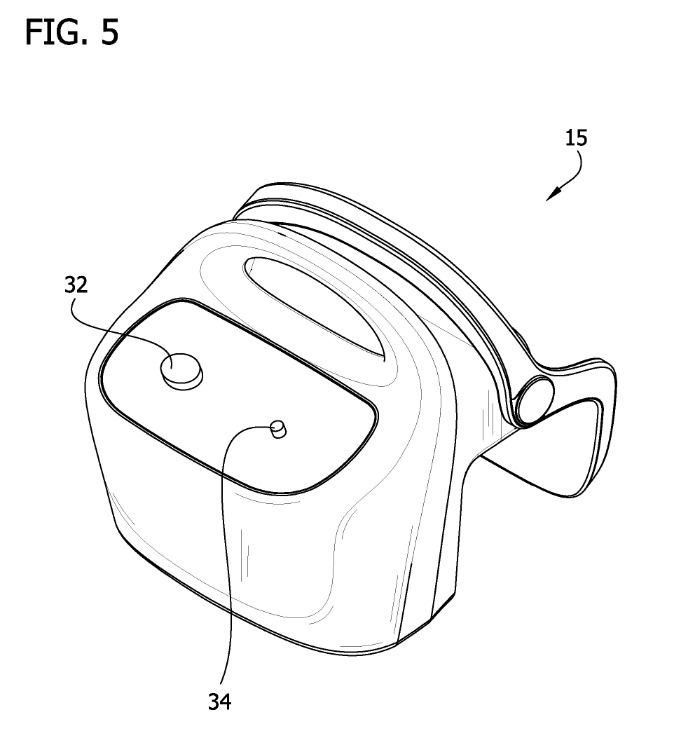

Referring to FIG. 2, the processor 19 has a pause function 25 including a pause algorithm 27 so that the user and/or clinician can pause compression therapy for a set period of time without having to completely turn off or reset the compression device 11. A “user” or “clinician” are broadly and collectively referenced herein as an “operator”, and includes at least the patient wearing the compression device, doctors, and nurses. A switch 31 (FIG. 1) is provided on the controller 15 to initiate the pausing of the compression therapy and set the desired period of time for pausing compression therapy. In one embodiment, the switch 31 can be a depressible button 32 (FIG. 5). In one embodiment, the button will be sized, colored and/or positioned to be prominent, or at least more prominent that any buttons or switches 34 provided for turning on or off (or otherwise resetting) the entire compression device. This will facilitate use of the pause function by the operator in preference to turning off the compression device, which is usually not desirable until treatment is concluded. But other types of switches (e.g., a touch screen) may be used without departing from the scope of the invention. An indictor 33 on the controller 15 is provided to signal to the operator when the set period of time for pausing the compression device 11 has elapsed. The indicator 33 can be a visual indicator such as a light, an audio indicator such as an audible alarm or any other suitable indication means for alerting the operator. A timer 35 is operatively connected to the processor 19 and is initiated for the set period of time when the switch 31 is engaged. A timer can be integrated into the processor within the scope of the present invention.

The controller 15 can be programmed so that the compression device 11 operates in a “suspend mode” wherein once the switch 31 is engaged, the device pauses the compression therapy for a set period of time. When that set period of time elapses, the timer 35 signals to the processor 19 to activate the indicator 33 to alert the operator that the selected period of time for pausing compression therapy has elapsed. This notifies the operator that it is time to reinitiate the compression therapy.

The controller 15 can also be programmed so that the compression device 11 operates in a “sleep mode” wherein once the switch 31 is engaged; the device pauses compression therapy for a set period of time and then automatically reinitiates compression therapy once the period of time has elapsed. This eliminates the need for the user or clinician to manually restart therapy. Because some patients have trouble falling asleep while compression therapy is being applied, the compression device is often simply removed for the night, which does not provide the needed therapy throughout the night. The sleep mode may enable a patient to more easily fall asleep by pausing the compression therapy for a set period of time and then automatically restarting therapy once the patient has fallen asleep.

The period of time for pausing compression therapy can also be adjusted by repeated engagement of the switch 31. Therefore, if the switch 31 is a depressible button 32, repeated pressing of the button will cycle through an available amount of predetermined times for pausing the compression therapy. In one configuration, pressing the button 32 once will set the timer 35 to pause compression therapy for 15 minutes, pressing the button twice will set the timer to pause compression therapy for 30 minutes and pressing the button three times will set the timer to pause compression therapy for 60 minutes. It is envisioned that the button presses can pause the compression therapy for different increments of time without departing from the scope of the invention. And the operator may also use the button 32 to set a more specific amount of time to pause compression therapy rather than increasing the time by preset increments. The ability to adjust the period of time that compression treatment is suspended will allow for a more customized usage of the compression device 11 better suiting the needs of the user.

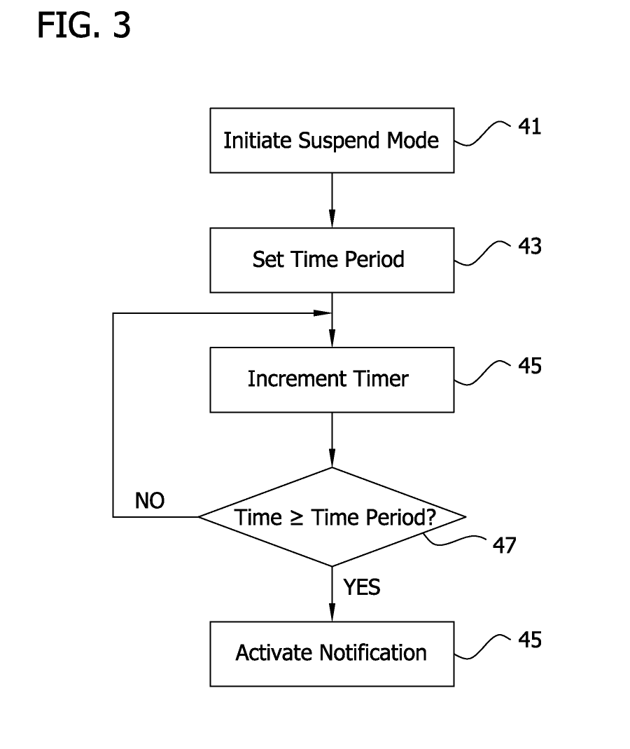

In one embodiment the pause algorithm 27 provides a “suspend mode” that operates generally in accordance with the simplified flow diagram shown in FIG. 3. Initiation of the suspend mode at step 41 may be carried out by toggling the switch 31 described above. The program then proceeds to set the time period of the suspension at step 43. The time may be pre-set and stored in a memory associated with the processor 19, or may be set by the user or clinician such as in the ways described previously herein.

Once the suspend mode is activated at step 41 and the suspension time period is set at step 43, operation of the compression device 11 is suspended. Preferably, the device 11 is not shut down or reset, but instead suspends operation while retaining all pertinent settings and information necessary to resume operation without re-booting or re-entering operational settings. In a shut down or other reset condition, prior treatment setting are lost. However, in the present invention, for example, a previously determined vascular refill time (VRT) and/or pump speed may be retained and used immediately when operation is re-initiated. In addition, start-up checks, such as sleeve detection features, may be skipped following a suspend mode to return the compression device 11 to operation with the previous settings utilized at the moment before the suspend mode was activated. This use of previous settings may provide a faster reinitiating of the compression device 11, which would save operator time.

At step 45, the timer is incremented and then the time is compared at step 47 with the time period set previously. The algorithm loops until the time is greater than or equal to the set time period. The pause algorithm 27 then proceeds to activate notification at step 49. Notification can take on any suitable form, such as those described previously herein. Operation of the compression device 11 does not begin automatically, but requires the intercession of the user or clinician to restart. The device 11 retains all previously entered operation settings and information so that it can immediately begin to operate with the simple push of button 32 or the like.

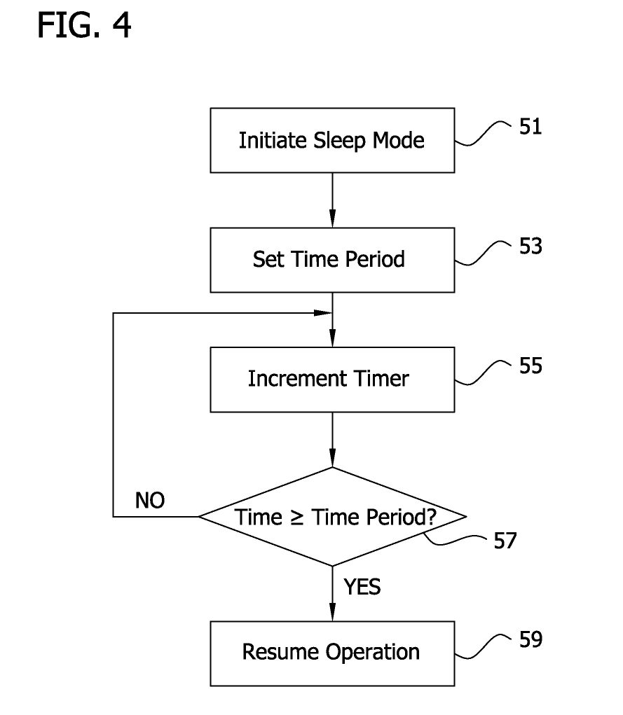

A sleep mode version of the pause algorithm 27 is shown in FIG. 4. Initiation of the sleep mode at 51 can be accomplished in any suitable manner such as by toggling the switch 31. As in the suspend mode version of the pause algorithm 27, a time period may be set at step 53 automatically or by action of the user or clinician. Once the time period is set, the pause algorithm 27 proceeds to step 55 where the operation of the compression device 11 is suspended substantially as described hereinbefore with regard to the suspend mode. The time is incremented at step 55 and checked at step 57 until the time equals or exceeds the set time period. In the sleep mode version of the pause algorithm 27, the compression device 11 is automatically reactivated at step 59 to resume the prior compression operation. No intervention by the user or clinician is required in the sleep mode. It will be appreciated that the compression device 11 may have one or both of the suspend mode and the sleep mode.

Having described the invention in detail, it will be apparent that modifications and variations are possible without departing from the scope of the invention defined in the appended claims. Counter intuitively, by providing an easier way for the clinician (or user) to pause operation of the compression device (whether in the suspend mode or sleep mode), better compliance may be achieved. In part, this is because provision is made to actively notify the clinician to restart operation in the suspend mode, or to automatically restart operation in the sleep mode.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A compression device for providing compression treatment to a limb of a wearer, the device comprising:
a compression garment positionable on the limb of the wearer, the garment comprising at least one inflatable bladder for providing compression treatment to the limb; and
a controller adapted for fluid connection with the inflatable bladder and configured for cyclically inflating and deflating the bladder to provide the compression treatment, the controller being configured to temporarily pause the compression treatment for a set period of time without resetting the compression device.

2. A compression device as set forth in claim 1 wherein when the device is paused the device retains all pertinent operational settings and information necessary to resume compression treatment without having to re-boot or re-enter the operational settings prior to resuming compression treatment.

3. A compression device a set forth in claim 1 wherein the controller is configured to signal to an operator to resume compression treatment after the set period of time has elapsed.

4. A compression device as set forth in claim 1 wherein the controller is configured to automatically resume compression treatment after the set period of time has elapsed.

5. A compression device a set forth in claim 1 further comprising a switch operatively connected to the controller for initiating the controller to pause the compression treatment.

6. A compression device as set forth in claim 5 wherein the switch is operable to select the set period of time for pausing the compression treatment.

7. A compression device as set forth in claim 6 wherein the switch is a depressible button.

8. A compression device as set forth in claim 7 wherein the button is more prominent than any button or switch on the compression device for turning the device on and off.

9. A compression device as set forth in claim 6 wherein the controller includes a timer configured to be set to the set period of time upon operation of the switch.

10. A compression device as set forth in claim 9 further comprising an indicator operatively connected to the controller for signaling to an operator when the set period of time has elapsed.

11. A method of providing compression treatment to a limb of a wearer using a compression device including an inflatable bladder positioned on the limb of the wearer and a controller in fluid connection with the inflatable bladder, the method comprising:
initiating compression treatment by cyclically inflating and deflating the bladder with pressurized fluid from the controller to compress the limb of the wearer; and
temporarily pausing the compression treatment for a set period of time without resetting the compression device.

12. A method as set forth in claim 11 wherein the device is paused such that the device retains all pertinent operational settings and information necessary to resume compression treatment without having to re-boot or re-enter the operational settings prior to resuming compression treatment.

13. A method as set forth in claim 11 further comprising signaling to an operator to resume compression treatment after the set period of time has elapsed.

14. A method as set forth in claim 11 further comprising automatically resuming compression treatment after the set period of time has elapsed.

15. A controller for a compression device adapted to provide compression treatment to a limb of a wearer, the controller being adapted for fluid connection with an inflatable bladder of the compression device and configured for cyclically inflating and deflating the bladder to provide the compression treatment, the controller including a processor programmed to temporarily pause the compression treatment for a set period of time without resetting the compression device.

16. A controller as set forth in claim 15 wherein the controller pauses the device such that the controller retains all pertinent operational settings and information necessary to resume compression treatment without having to re-boot or re-enter the operational settings prior to resuming compression treatment.

17. A controller as set forth in claim 15 further comprising an indicator, the processor being programmed to activate the indicator to signal to an operator to resume compression treatment after the set period of time has elapsed.

18. A controller as set forth in claim 15 wherein the processor is programmed to automatically resume compression treatment after the set period of time has elapsed.

19. A controller as set forth in claim 15 further comprising a switch operable to select the set period of time for pausing the compression treatment.

20. A controller as set forth in claim 19 wherein the switch is a depressible button, the button being more prominent than any button or switch on the compression device for turning the device on and off.
